(19) United States
(12) Patent Application Publication
(10) Pub. No.: US 2024/0349236 A1
(43) Pub. Date: Oct. 17, 2024

(54) CELLULAR CONNECTIVITY AND QOS MONITORING AND PREDICTION FOR UAV COMMUNICATION

(71) Applicant: InterDigital Patent Holdings, Inc., Wilmington, DE (US)

(72) Inventors: Guanzhou Wang, Brossard (CA); Samir Ferdi, Kirkland (CA); Taimoor Abbas, Sainte-Julie (CA)

(73) Assignee: InterDigital Patent Holdings, Inc., Wilmington, DE (US)

(21) Appl. No.: 18/293,998

(22) PCT Filed: Aug. 3, 2022
(86) PCT No.: PCT/US2022/039239

§ 371 Date: Jan. 31, 2024

Related U.S. Application Data
(60) Provisional application No. 63/230,229, filed on Aug. 6, 2021.

(51) Int. Cl. H04W 64/00; H04W 28/02

(52) U.S. Cl. CPC H04W 64/006; H04W 28/0226; H04W 28/0236

(57) ABSTRACT

Cellular connectivity and quality of service (QOS) monitoring and prediction are provided for unmanned aerial vehicle (UAV) communication. A core network (CN) may select assisting UAVs for communication link monitoring according to a target UAV's flight route. The CN may receive the assisting UAV's monitoring report, which may be used to derive a communication link quality prediction for the target UAV's flight path. The target UAV may discover and select an adjacent pilot UAV, which flies ahead of the target UAV's trajectory. The target UAV may receive a monitoring report from the pilot UAV, which may be used to predict a communication link quality for the target UAV's flight path. An unmanned aerial system (CAS) network function (NF) may collect QOS monitoring information from other NFs for a predetermined/popular flight route. The UAS NF may provide a prediction to the USS (e.g., upon request).

### CROSS REFERENCE

This application claims the benefit of U.S. Provisional Application No. 63/230,229 filed on Aug. 6, 2021, which is incorporated herein by reference as if fully set forth.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for cellular connectivity and quality of service (QOS) monitoring and prediction for unmanned aerial vehicle (UAV) communication.

A core network (CN) may select one or more WTRUs, which may be UAVs, for communication link monitoring according to a target WTRU's (e.g., target UAV's) flight route. The one or more WTRUs performing the communication link monitoring may be referred to as assisting WTRUs (e.g., assisting UAVs). The CN may receive the assisting WTRU's monitoring report, which may be used to derive a communication link quality prediction for the target WTRU's flight path.

The target WTRU may discover and select another WTRU may that be within a distance of the target WTRU. For example, the target WTRU may discover and select an adjacent WTRU (e.g., an adjacent pilot UAV) that may fly ahead of the target WTRU's (e.g., target UAV's) trajectory. The target WTRU (e.g., target UAV) may receive a monitoring report from the other WTRU (e.g., the adjacent pilot UAV), which may be used to predict a communication link quality for the target WTRUs (e.g., target UAV's) flight path.

An unmanned aerial system (UAS) network function (NF) may collect quality of service (Qos) monitoring information from one or more other NFs for a flight route (e.g., a predetermined/popular flight route). The UAS NF may determine a prediction associated with the flight route. The UAS NF may provide the prediction to the USS (e.g., upon request).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example system architecture for supporting an unmanned aerial system (UAS) service.

FIG. 3 illustrates an example of collecting communication link monitoring information from one or more WTRUs, which may be assisting unmanned aerial vehicles (UAVs).

FIG. 4 illustrates an example of a procedure of cellular communication link monitoring assisted by one or more WTRUs, which may be one or more UAVs.

FIG. 5 illustrates an example of a procedure for cellular communication link monitoring assisted by a WTRU, which may be a pilot UAV.

FIG. 6 illustrates an example of a procedure for cellular communication link monitoring assisted by a WTRU, which may be a pilot UAV.

### EXAMPLE NETWORKS FOR IMPLEMENTATION OF THE EMBODIMENTS

Systems, methods, and instrumentalities are described herein for cellular connectivity and quality of service (QOS) monitoring and prediction for unmanned aerial vehicle (UAV) communication. A core network (CN) may select one or more wireless transmit/receive units (WTRUs), which may be assisting UAVs, for communication link monitoring according to a target WTRU's (e.g., a UAV's) flight route. The CN may receive the assisting WTRU's (e.g., the assisting UAV's) monitoring report, which may be used to derive a communication link quality prediction for the target WTRU's (e.g., target UAV's) flight path. The target WTRU may discover and select an another WTRU that may be within a distance of the target WTRU. The other WTRU may be an adjacent pilot UAV. The other WTRU may fly ahead of the target WTRU's trajectory. The target WTUR (e.g., target UAV) may receive a monitoring report from another WTRU (e.g., the pilot UAV), which may be used to predict a communication link quality for the target WTRU's flight path. An unmanned aerial system (UAS) network function (NF) may collect QoS monitoring information from other NFs for a predetermined/popular flight route. The UAS NF may provide a prediction to the USS (e.g., upon request).

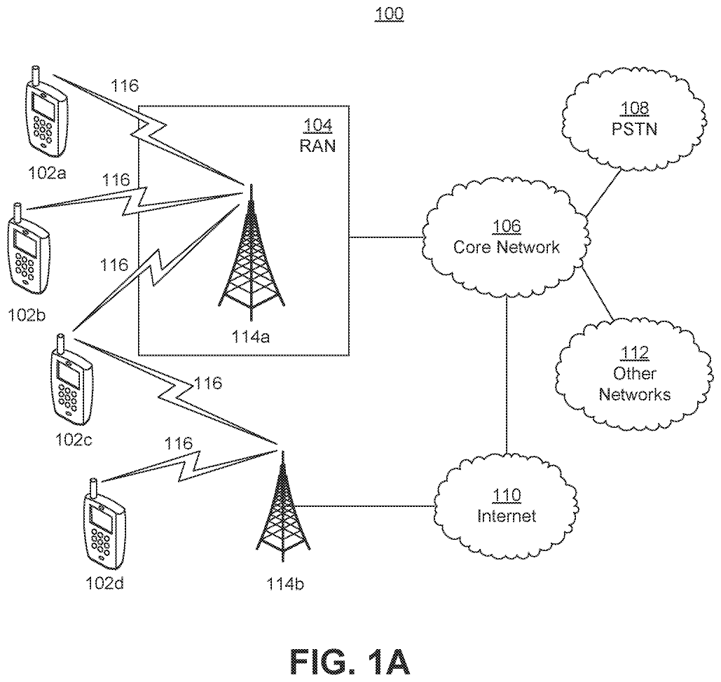

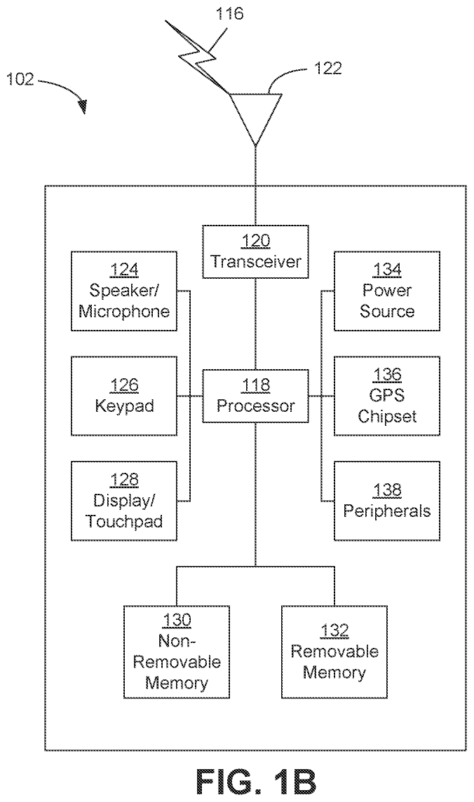

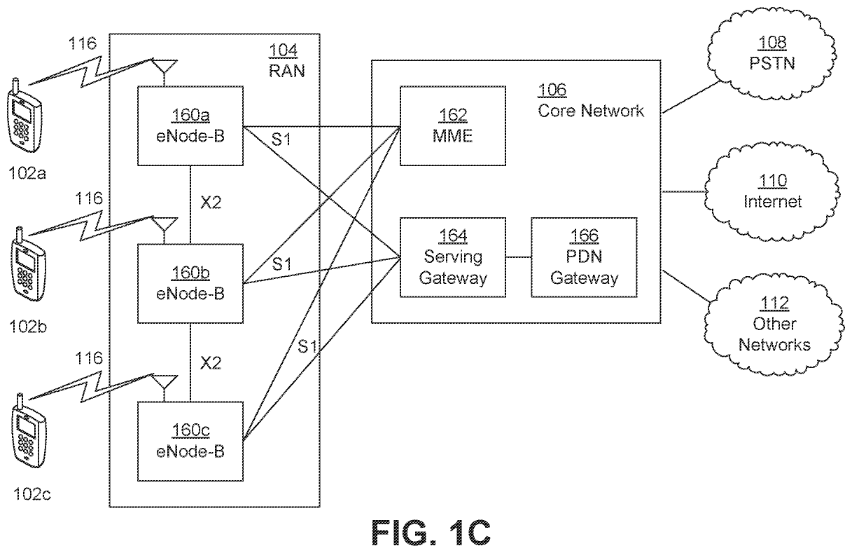

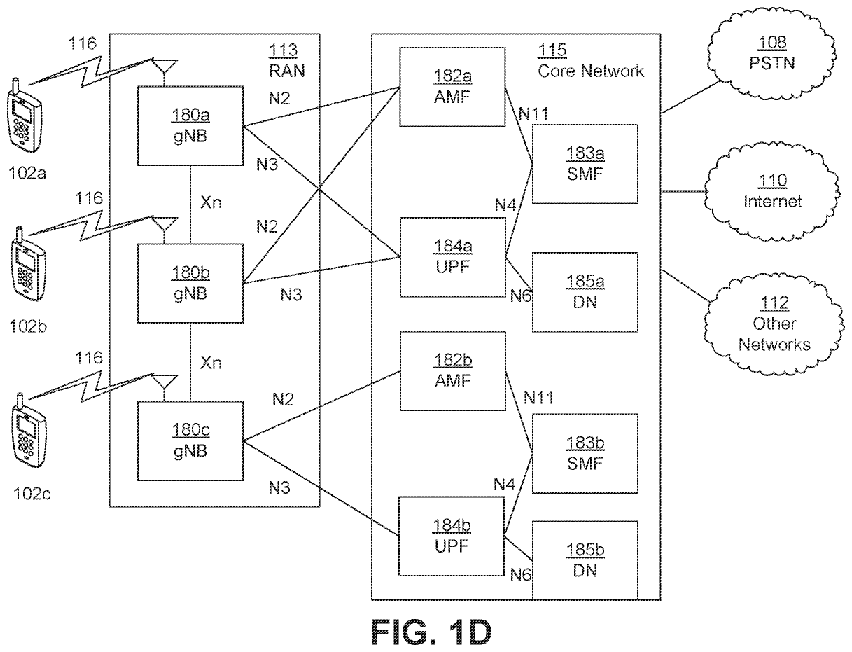

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Cellular connectivity may be provided. Quality of service (QOS) monitoring and/or prediction may be provided, for example, for cellular connectivity. Cellular networks may enable beyond-visual-line-of-sight (BVLOS) drone operations. The reliability of cellular connectivity, such as for unmanned aerial vehicle (UAV) command and control communications, may support the safety and/or success of a UAV mission. Cellular networks may offer (e.g., UAVs) connectivity with technology, such as 4G/5G technology, and/or may provide features for improving QoS and reliability. A UAV flight may be controlled via cellular connectivity.

In examples described herein, a WTRU may be a UAV, may be associated with a UAV, may be contained within a UAV, a combination thereof, and/or the like. For example, a UAV may include a WTRU such that the UAV may communicate with a network using the WTRU. In another example, the WTRU may be a UAV and may communicate with the network.

A drone (e.g., UAV or a WTRU) operator may use coverage data from the mobile network operators (MNOs) to plan a (e.g., an optimal) flight route. A drone operator may not have advance knowledge whether a flight may be disrupted, for example, due to a QoS degradation of cellular connectivity. There may be an interface between cellular network(s) and an unmanned aerial system (UAS) service supplier (USS), for example, to share coverage data. A cellular network may provide information (e.g., real-time link status information) that may support flight planning and/or control. In an example, the cellular network may ensure information for flight planning and/or control may be delivered (e.g., in real-time).

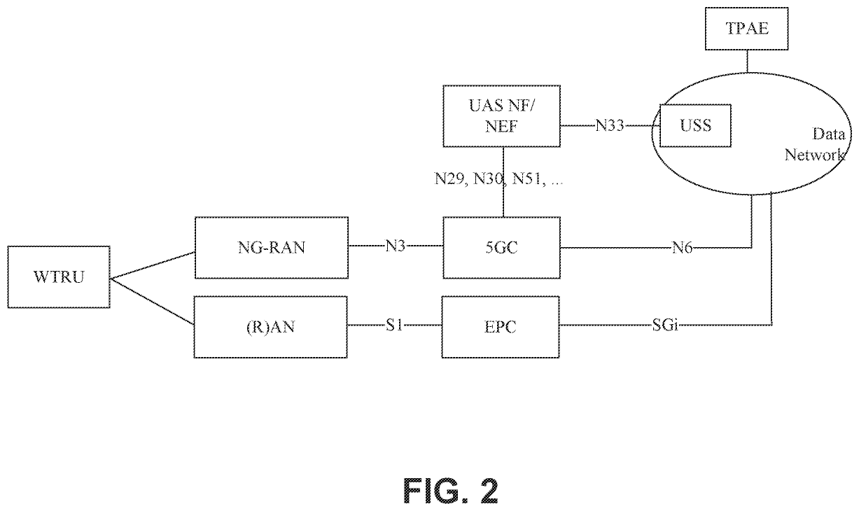

A network may produce information for communication link status and/or QoS monitoring for WTRU and/or UAV communications. FIG. 2 illustrates an example system architecture for supporting a UAS service (e.g., in 5G core (5GC)/evolved packet core (EPC)). UAS service support may include, for example, UAS connectivity, identification, and/or tracking functionalities. A network function (NF), which may be referred to as UAS NF, may support UAS service functionalities.

A UAS NF may provide (e.g., perform), for example, at least a portion of the role(s) of a network exposure function (NEF), e.g., to expose service(s) to a (e.g., an external) USS. A UAS NF may (e.g., also) support one or more UAS-specific procedures, such as USS UAV authentication and authorization (UUAA) and/or UAS tracking. A UAS NF may (e.g., also) store a UAS context, such as a UUAA result.

The following acronyms are used herein:
5GC: 5G Core
A&A: Authentication and Authorization
BVLOS: Beyond Visual Line of Sight
C2: Command and Control
CAA: Civil Aviation Authority
CM: Connection Management
CN: Core Network
EPC: Evolved Packet Core
GPSI: Generic Public Subscriber Identity
KPI: Key Performance Indicators
MNO: Mobile Network Operator
NEF: Network Exposure Function
NWDAF: Network Data Analytics Function (NWDAF)
PC5: The reference point between ProSe-enabled UEs
Prose: Proximity Service
RSRP: Reference Signal Received Power
RSRQ: Reference Signal Received Quality
RSSI: Received Signal Strength Indicator
SINR: Signal to Interference & Noise Ratio
TAI: Tracking Area Identifier
TPAE: Third Party Authorized Entity
UAV: Unmanned (or Uncrewed) Aerial Vehicle
UAS: Unmanned (or Uncrewed) Aerial System
UAS NF: UAS Network Function
USS: UAS Service Supplier
UP: User Plane
UPF: User Plane Function
UTM: UAS Traffic Management

QoS monitoring and reporting mechanisms in cellular networks may provide (e.g., current) key performance indicators (KPis) of sessions. The KPIs may be one current sessions, ongoing sessions, live sessions, past session, previous sessions, a combination thereof and/or the like. QoS monitoring and reporting may or may not (e.g., have a capability to) predict future KPIs. For example, one or more KPIs may be predicted if/when a WTRU may move to a different area. Predicting a quality of a communication link (e.g., with a high confidence level) for UAS operations may help a flight planner select/choose a (e.g., an optimal) flight route and/or may help a flight controller (e.g., dynamically) adjust a route to avoid areas and/or altitudes with poor wireless coverage.

A network may provide a prediction (e.g., in real-time) of the KPIs of a cellular communication link, for example, based on a planned flight route. The QoS related metrics or events reported by cellular networks may be generated at various network entities or functions, such as base stations and/or or user plane gateways. Metrics or events reported by cellular networks may or may not be associated with a WTRU's location and/or vertical dimension (e.g., altitude) to support UAV flight. QoS metrics or events generated by cellular networks may or may not be sufficient for an aviation management system or controller to plan and/or adjust a flight route.

A network may provide (e.g., real-time, three-dimensional) QoS metrics of cellular communication links for UAS operation. A prediction may be based on QoS related metrics or events reported to the network by various network entities. Metrics and events may be influenced by various factors and/or may be applicable during a certain time window for which a prediction is made based on past events. In some cases, a network-based predication may be irrelevant due to unexpected network failures. For example, regardless of the quality of a planned route and/or a prediction on which the plan may be based, one or more unexpected events may occur during the time of flight and a QoS metric may not be fulfilled for one or more operations. A WTRU-based prediction may (e.g., to support safety and reliability) complement network-based prediction, for example, to adjust a flight route or bring a UAV to safe stop (e.g., in case of network failure).

A network may configure a WTRU and/or a UAV to predict real-time QoS and/or react based on (e.g., upon certain) network degradation or failure.

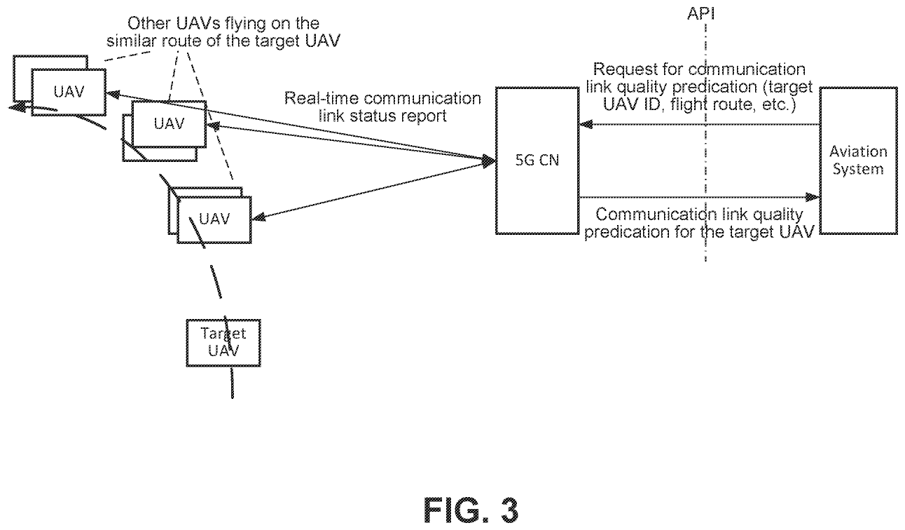

Communication link prediction, communication link monitoring, QoS metric prediction, and/or QoS monitoring may be provided and/or assisted. For example, a communication link and/or QoS metric prediction/monitoring may be assisted, for example, by (e.g., direct) input from other WTRUs (e.g., assisting UAVs). A cellular core network (e.g., 5GC) may receive a request for QoS/communication link quality from an aviation system (e.g., USS). The aviation system may provide, for example, one or more of the following: identification (e.g., a general public subscription identifier (GPSI)) of the target WTRU and/or UAV, the flight plan/route, the QoS requirements, a combination thereof, and/or the like. The core network (CN) may (e.g., based on the information) attempt/try to locate other WTRUs and/or UAVs that may be (e.g., currently) flying or (e.g., and/or may have flown, for example, in the recent past, such as seconds, minutes, or hours earlier) in the same or adjacent areas/altitudes that are in the planned route of the target UAV. The CN may (e.g., directly) request those WTRUs and/or UAVs to provide communication link quality information and/or QoS metrics associated with their locations and altitudes. A network may leverage one or more WTRUs and/or UAVs (e.g., one or more currently flying UAVs) to crowdsource QoS monitoring in one or more areas of interest for the aviation system. A CN may (e.g., based on the inputs of the WTRUs and/or UAVs) generate a prediction of communication link quality/QoS metrics for the (e.g., planned) flight route of the target WTRU (e.g., target UAV). The CN may provide the prediction to the aviation system. A high-level illustration of an example is shown in FIG. 3.

FIG. 3 illustrates an example of collecting communication link monitoring information from one or more WTRUs, which may be assisting UAVs. A cellular CN (e.g., 5GC) may receive a request for communication link quality monitoring and/or prediction from an aviation system (e.g., USS, UAV controller (UAV-C), and/or third party authorized entity (TPAE). A network function (NF) that handles the request (e.g., UAS NF in 5GC) may map the flight route to (e.g., a few) continuous segments that may be mapped to areas (e.g., tracking area identifiers (TAIs), cell IDs, etc.) within a (e.g., 3GPP) network. The NF may (e.g., try to) identify whether (e.g., determine if) there are other WTRUs and/or UAVs (e.g., currently flying and/or that have flown) in the same or adjacent area and altitude. An NF may use, for example, one or more of the following methods.

A network function (e.g., UAS NF and/or a NWDAF) may query one or more USS, which may possess tracking information for (e.g., all) WTRUs and/or UAVs authorized by the USS, for a list of (e.g., currently flying) WTRUs and/or UAVs that generated/are generating information in the target flight route segments. A USS may provide the requested list of WTRUs and/or UAVs. A USS may identify WTRUs and/or UAVs by identifications (e.g., UAV identifications, WTRU identifications, and/or the like), such as civil aviation authority (CAA)-level UAV IDs.

A network function (e.g., UAS NF and/or NWDAF) may receive (e.g., may constantly receive) tracking information (e.g., UAV identification, WTRU identification, location, altitude, etc.) of one or more WTRUs (e.g., one or more UAVs, which may be flying). A NF may (e.g., locally) store received information. A network function may look up WTRUs and/or UAVs in a (e.g., local) database to locate the WTRUs and/or UAVs (e.g., that may currently be flying) in the planned trajectory of the target WTRU (e.g., target UAV). The WTRUs and/or UAVs may establish user plane (UP) connectivity with the network function, for example, to report their tracking information to the NF. For example, a UAV may use a WTRU associated with the UAV to establish UP connectivity. As another example, a WTRU that may be a UAV may establish UP connectivity.

A network function may locate other network functions (e.g., access and mobility management functions (AMFs)) that may serve the WTRUs and/or UAVs in the areas associated with (e.g., mapped from) the target flight route. For example, one or more network functions associated with an area long a target flight route may be identified and/or discovered. The network function may request that the other network functions provide a list of WTRUs and/or UAVs (e.g., via WTRU identifications and/or via UAV identifications, such as CAA-level UAV ID or GPSI) that may currently be flying (e.g., and/or have flown) in the area. The other network functions (e.g., AMFs) may provide other (e.g., relative or related) information, such as whether (e.g., identified/listed) WTRUs and/or UAVs support assistance communication link/QoS monitoring information reporting.

The NF may locate the list of one or more WTRUs and/or UAVs that may currently be flying in one or more segments of the target flight route. The NF may check if (e.g., determine whether) a WTRU (e.g., each UAV) in the list has a subscription that may allow the WTRU (e.g., UAV) to provide the information and/or whether the WTRU (e.g., UAV) may be capable of reporting the information. A WTRU (e.g., each UAV) may provide WTRU and/or UAV capability information on whether it supports assisted communication link and/or QoS monitoring, for example, during a registration procedure. The NF may request the capable WTRUs and/or UAVs to provide communication link quality and QoS metrics information.

An NF may request WTRUs and/or UAVs to report an assisting communication link and/or Qos monitoring information, for example, using a control plane (CP)-based method or an UP-based method.

An NF (e.g., UAS NF) may send a request via non-access stratum (NAS) signaling, for example, using a CP-based method. The NF may locate the serving NF (e.g., AMF or session management function (SMF)) with the WTRU context and/or UAV context (e.g., UAV identifications, UUAA status, etc.). The NF may send the request for assisting communication link and/or QoS monitoring to the serving NF.

A request (e.g., by an NF) may include, for example, one or more of the following: WTRU identification and/or UAV identification (e.g., CAA-level UAV ID, GPSI), where a (e.g., single) request may include multiple WTRUs and/or UAVs (e.g., if they are served by the same NF); a target range of area and altitude for reporting (e.g., so that a UAV may send an assisting monitoring report if/when the UAV is in the target range of area and altitude); communication link monitoring KPIs (e.g., reference signal received power (RSRP), reference signal received quality (RSRQ), reference signal strength indicator (RSSI), signal to interference and noise ratio (SINR), handover frequency, radio link failure (RLF) frequency, etc.); QoS monitoring metrics (e.g., bit rates, latency, packet loss rate, etc.) for command and control (C2) communication and/or non-C2 communication; IP transport address (e.g., IP address/TCP port) for receiving the monitoring information (e.g., WTRUs and/or UAVs may send assisting monitoring information to the address via the UP); frequency of monitoring information reporting; and/or information for event-triggered reporting (e.g., thresholds for (certain) KPIs and QoS metrics).

For example, a threshold for C2 communication link latency may be specified. A C2 communication degradation event may be generated, for example, if the observed C2 communication link latency exceeds the threshold, which may trigger the WTRU and/or UAV to send an event report to the NF. For example, a threshold for handover frequencies may be specified. An excessive handover event may be generated, for example, if the observed number of handovers (e.g., in a (short) period of time) exceeds the threshold, which may trigger the WTRU and/or UAV to send an event report to the NF.

The serving NF (e.g., AMF or SMF) may forward the request (e.g., by an NF) to one or more WTURs (e.g., UAVs), for example, in NAS signaling (e.g., a downlink (DL) NAS transport).

One or more WTRUs (e.g., UAVs) may receive a request. A WTRU (e.g., UAV) may determine whether to accept or decline a request, for example, based on local configurations and/or other conditions (e.g., battery level). A UAs may send responses to the serving NF (e.g., AMF or SMF), for example, in NAS signaling (e.g., a UL NAS transport message). The serving NF may forward the responses to the requesting NF (e.g., UAS NF).

A WTRU (e.g., A UAV that accepted a request to send WTRU assisted communication link and QoS monitoring information) may collect (e.g., start collecting) the communication link quality KPIs and QoS metrics, for example, if/when the criteria are met. The criteria may be if/when a WTRU (e.g., a UAV) may be within a distance of the target range of area and/or altitude. The criteria may be if/whether a WTRU (e.g., a UAV) supports a functionality, such as sending a QoS report. The criteria may be if/when it is determined that a UAV may be experiencing degradation in QoS and/or may wish to adjust a flight path. A WTRU (e.g., a participating/cooperating UAV) may (e.g., periodically) send the collected information to the specified address (e.g., recipient). An event-triggered report may be sent to the NF, for example, in addition and/or as an alternative to a periodical monitoring report.

A periodical monitoring report may include, for example, one or more of the following information: WTRU identification, UAV identification (e.g., GPSI, CAA-level UAV ID); a tracking information (e.g., location, altitude, speed, direction, etc.) for a UAV; observed communication link KPIs and/or QoS metrics; and/or a timestamp of the report (e.g., the time the report was generated).

A WTRU (e.g., a UAV) may stop monitoring and/or sending a report (e.g., and may notify the NF that the WTRU and/or UAV has aborted monitoring and/or reporting), for example, if/when the criteria for WTRU assisted QoS monitoring are not met. For example, a WTRU (e.g., a UAV) may stop monitoring and/or sending a report if/when the WTRU (e.g., UAV) has flown out of the specified range of area and altitude and/or for other (e.g., local) reasons (e.g., WTRU and/or UAV battery level may be low).

A WTRU (e.g., UAV) may be unable to send a report due to a communication failure (e.g., RLF). A WTRU (e.g., UAV) may store one or more reports. The WTRU and/or UAV may send the report(s) to the NF, for example, if/when cellular communication resumes.

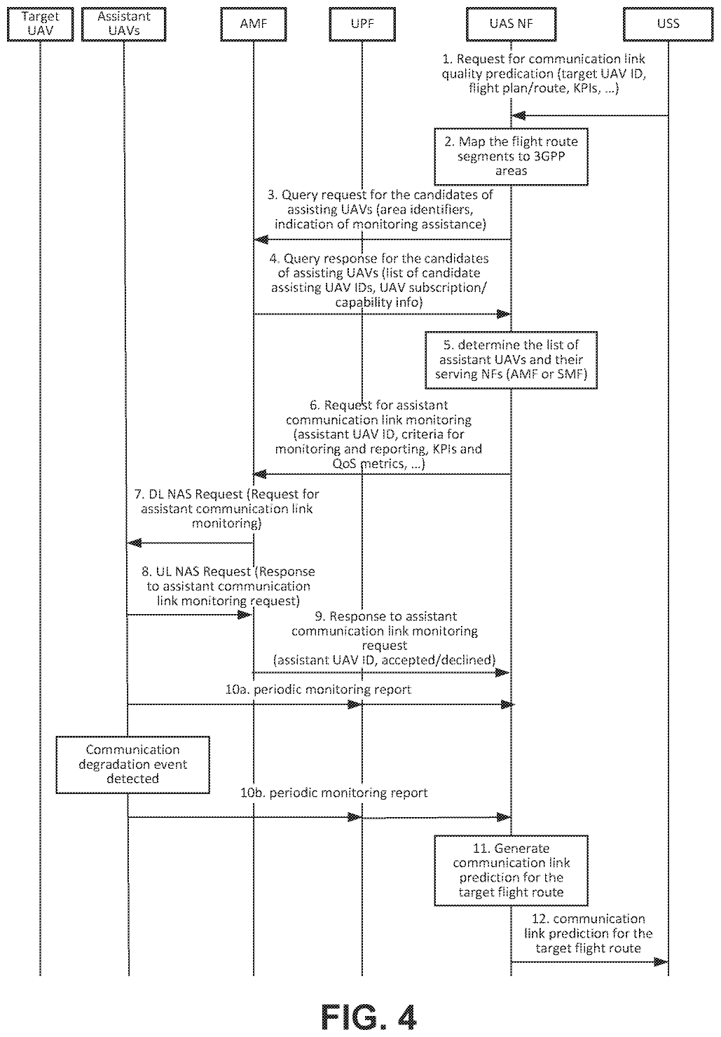

An NF (e.g., UAS NF) may (e.g., based on the collected reports from one or more participating UAVs) derive (e.g., predict) a communication link quality and QoS prediction for a planned flight route of a target UAV. An NF may return the derived/prediction results to the requesting aviation system. An example of the foregoing example procedure may be shown in FIG. 4.

FIG. 4 illustrates an example of a procedure of cellular communication link monitoring assisted by one or more WTRUs, which may be one or more UAVs. As shown by example in FIG. 4, at 1, a UAS NF (e.g., in 5GC) may receive a request for communication link quality prediction from an USS. The USS may provide relevant input (e.g., information), such as one or more of the target UAV IDs (e.g., GPSI, CAA-level UAV ID), WTRU IDs, flight plan/route (e.g., a series of waypoints), KPIs of the communication link to be monitored (e.g., wireless signal strength/quality, communication latency), a combination thereof, and/or the like.

At 2, the UAS NF may dissect the flight route into multiple segments. The UAS NF may map the segments to areas. An area may be an area associated with a cellular cell, a way point, a base station, a WTRU, a UAV, a combination thereof, and/or the like. For example, waypoints that are covered by different cellular cells, or waypoints that may be within a cell but have different altitudes, may belong to (e.g., may be mapped to) different segments.

At 3, the UAS NF may identify one or more serving AMFs for the flight segments. The UAS NF may invoke the AMF service to (e.g., try to) retrieve a list of one or more WTRUs (e.g., UAVs) that may be (e.g., currently) served by the AMF. The UAS NF may indicate it is interested (e.g., only) in WTRUs and/or UAVs that may be capable of assisted communication link/QoS monitoring.

At 4, the AMF may return a list of one or more WTRU IDs (e.g., UAV IDs) that may be capable of assisted monitoring. The AMF may provide the list of the one or more WTRU IDs and/or UAV IDs, UAV context information (e.g., CAA-level UAV ID, CM state (IDLE or Connected), WTRU capability information, etc., a combination thereof, and/or the like.

At 5, the UAS NF may (e.g., based on the list and/or other context information received from the AMF) look up (e.g., real-time) tracking information (e.g., in a local database, assuming the WTRUs and/or UAVs send/sent tracking info to the UAS NF) and/or retrieve tracking information from the USS. The UAS NF may compare the tracking information of the one or more WTRUs and/or UAVs. The UAS NF may compare the tracking information of the WTRUs and/or UAVs to the target flight route segments, for example, to determine the (e.g., zero or more) candidate assisting WTRUs and/or UAVs. A WTRU (e.g., a UAV) may be selected as an assisting WTRU and/or UAV, for example, if the WTRU (e.g., UAV) is flying (e.g., and/or has flown) in the area, may be in a similar (e.g., adjacent) area, may be flying at an altitude similar to the target flight route segment, and/or may be near an altitude of a target flight route segment.

At 6, the UAS NF may send a request for assisted communication link/QoS monitoring to the AMF that serves the selected assisting WTRU and/or UAV. Multiple requests may be sent to various AMFs, for example, if multiple assisting WTRU and/or UAVs are selected (e.g., and served by different AMFs).

At 7, the AMF may forward the request to the WTRU and/or UAV (e.g., in NAS signaling).

At 8, the candidate assisting WTRU and/or UAV may determine whether to accept or decline the request, for example, based on a (e.g., local) configuration and/or other conditions. The candidate assisting WTRU and/or UAV may send a response to the AMF (e.g., in NAS signaling). A candidate assisting WTRU and/or UAV may become an assisting WTRU and/or UAV, for example, if the candidate assisting WTRU (e.g., UAV) accepts the request.

At 9, the AMF may forward the response to the UAS NF.

At 10a, an assisting WTRU and/or UAV (e.g., that accepted the request) may (e.g., start to) collect the requested monitoring KPIs/metrics and/or may report the collected KPIs/metrics to the designated address, for example, if one or more conditions for activating a monitoring report is/are met (e.g., the WTRU and/or UAV is (or was, such as in the recent past) within a distance of the target range of location/altitude). The reported KPIs/metrics may be associated, for example, with a timestamp (e.g., indicating the time the metrics are generated) and/or location information (e.g., three-dimensional (3D) location information).

At 10b, an assisting WTRU and/or UAV may report communication failure/degradation events, e.g., if they are detected. The reported events may be associated with a timestamp (e.g., indicating the time the metrics are generated) and/or location information (e.g., three-dimensional location information).

At 11, the UAS NF may collect (e.g., continue collecting) the monitoring report from one or multiple assisting UAVs for a period of time. The UAS NF may derive a prediction for the communication link quality and/or QoS metrics for the target WTRU's (e.g., target UAV's) flight route. The UAF NF (e.g., having no further need for information to generate one or more predictions before and/or during a target UAV's flight route) may indicate to the assisting WTRU(s) and/or UAV(s) that they may stop the monitoring and reporting.

At 12, the UAS NF may return one or more prediction results to the USS.

In some examples, communication link and/or QoS metric prediction/monitoring may be assisted by a WTRU, which may be a pilot UAV, via a link such as a PC5 link. A flying target WTRU (e.g., a target UAV) may search for other (e.g., currently or recently nearby or adjacent) WTRUs (e.g., UAVs) that are flying (e.g., or may have flown) in the area/altitude that the target WTRU (target UAV) is going to enter and select one or more of the other WTRUs (e.g., UAVs) as a pilot UAV. A target WTRU (e.g., target UAV) may establish a PC5 link with a selected pilot UAV. A target WTRU (e.g., target UAV) may request the pilot WTRU (e.g., pilot UAV) to provide communication link and/or QoS monitoring information over the PC5 link. The target WTRU (e.g., target UAV) may forward the received monitoring information to the aviation system (e.g., USS, UAV-C, TPAE). An aviation system may use the monitoring information to (e.g., determine whether to) adjust the flight route of the target WTRU (e.g., target UAV). The target WTRU (e.g., target UAV) may change to a backup route, for example, if the target WTRU (e.g., target UAV) determines there is a risk of communication degradation/failure based on received monitoring information (e.g., relative to one or more thresholds).

The pilot WTRU (e.g., the pilot WTRU) may provide communication link info to the target WTRU (e.g., UAV) over a link (e.g., a direct link), such as a PC5 link. By providing the communication link info, the pilot WTRU may pilot the target WTRU. The target WTRU (e.g., target UAV) may fly over the same or similar air space that the pilot WTRU (e.g., pilot UAV) may have passed, so the information from pilot UAV may be helpful to the target WTRU (e.g., target UAV). For example, if a pilot WTRU (e.g., pilot UAV) just flied over a coverage hole, it may provide that information to the target WTRU (e.g., target UAV), which may adjust its route to avoid that coverage hole.

Discovery of one or more candidate pilot WTRUs (e.g., pilot UAVs) by the target WTRU (e.g., target UAV) may be based on, for example, one or more proximity services (ProSe) discovery mechanisms. A UAS NF may serve a role of ProSe function and/or (e.g., 5G) direct discovery name management function (DDNMF) or interface. A UAS NF may perform a ProSe or DDNMF function or interface, for example, to manage discovery service authorization and/or assignment of various codes (e.g., ProSe application code, ProSe restricted code, ProSe query/response code, etc.) that may be used in (e.g., ProSe) discovery.

A WTRU and/or UAV that supports a piloting function may indicate the capability, for example, in a registration and/or protocol data unit (PDU) session/packet data network (PDN) connection establishment procedure. The cellular core network (e.g., 5GC) may (e.g., based on a WTRU subscription and network policy) approve or forbid a WTRU (e.g., UAV) to use a piloting function. Authorization for piloting may be provisioned by the network (e.g., policy control function (PCF)), for example, as parameters of the ProSe authorization policy provisioning. The CN may (e.g., additionally and/or alternatively) indicate the support of piloting, for example, if/when the CN initiates a UUAA procedure with the UAS NF and the USS. The USS may approve or forbid the WTRU (e.g., UAV) to use a piloting function (e.g., and may indicate approval or denial of piloting in a UUAA result).

A piloting-capable WTRU (e.g., a piloting-capable UAV) (e.g., approved to use a piloting function during flight) may activate a piloting function, for example, based on an instruction from the aviation system (e.g., USS, UAV-C, TPAE).

In some examples (e.g., if Mode A discovery is used), the piloting-capable WTRU and/or UAV (e.g., as an announcing WTRU) may receive the authorization and ProSe application code or ProSe restricted code from the UAS NF. The piloting-capable WTRU (e.g., piloting-capable UAV) may (e.g., start to) broadcast, for example, one or more of the following (e.g., over the PC5 channel): an indication of support for a piloting function; a WTRU ID, which may be a UAV ID; a UAV ID (e.g., CAA-level UAV ID); a ProSe application code or ProSe restricted code for a piloting service (e.g., the code may serve as an indication of support for a piloting function); and/or tracking information (e.g., the UAV's location, altitude, speed, direction, etc.).

The piloting-activated WTRU (e.g., piloting-activated UAV) may (e.g., also) monitor the piloting service request from other WTRUs and/or UAVs (e.g., over a PC5 channel).

The target WTRU (e.g., target UAV) may monitor (e.g., the PC5 channel) for candidate piloting WTRUs (e.g., piloting UAVs). The targeting WTRU (e.g., targeting UAV) may discover one or more WTRUs and/or UAVs that announce support for a piloting function (e.g., over the PC5 channel). The target WTRU (e.g., target UAV) may report the information received (e.g., over the PC5 channel) to a WTRU application (e.g., a UAV application), which may compare a candidate WTRU's tracking information (e.g., a candidate UAV's tracking information with the planned flight route for the target WTRU (e.g., target UAV) to determine whether the candidate WTRU (e.g., candidate UAV) is suitable for piloting purposes. The target WTRU (e.g., target UAV) may select a candidate WTRU (e.g., candidate UAV) as the piloting WTRU (e.g., piloting UAV). The target WTRU (e.g., target UAV0 may send (e.g., over the PC5 channel) a piloting service request (e.g., to the selected candidate pilot UAV). The piloting service request may include, for example, one or more of the following: an indication of a piloting request; the ProSe application code or restricted code associated with the piloting service (e.g., the code may serve as an indication of the piloting request); a WTRU ID, which may be a UAV ID; the UAV ID (e.g., CAA-level UAV ID) of the candidate piloting WTRU and/or UAV received from a discovery procedure; the UAV ID (e.g., CAA-level UAV ID) of the target WTRU and/or UAV; a piloting mode (e.g., periodical monitoring mode), by which the piloting WTRU and/or UAV may (e.g., periodically) send communication link/QoS monitoring information (e.g., over the PC5 link), and/or an event reporting mode, by which the piloting WTRU and/or UAV may send a report (e.g., only) if/when an event is detected (e.g., a communication failure/degradation event); and/or an authorization token authenticating the authorized piloting mode and/or indicating authorization to use the piloting service (e.g., the token may be provided to the WTUR and/or UAV by UAS NF/USS during the UUAA procedure).

The candidate piloting WTRU (e.g., the candidate piloting UAV) may receive the piloting service request. The candidate piloting WTRU (e.g., the candidate piloting UAV) may interact with the UAS NF and the USS, for example, to determine whether the requesting WTRU and/or UAV, (e.g., identified by the UAV ID in the request) is authorized to receive the monitoring information. The candidate piloting WTRU (e.g., the candidate piloting UAV) may (e.g., additionally and/or alternatively) verify the authorization token, e.g., if provided by the target WTRU (e.g., the target UAV). If authorized, information for one-to-one communication (e.g., PC5 direct communication), such as one or more of layer 2 (L2) identifiers, security credentials, authorized piloting mode, etc. may be assigned by the UAS NF for the requesting WTRU (e.g., requesting UAV) and the piloting WTRU (e.g., piloting UAV). In an example, information for one-to-one communication may be sent to the requesting WTRU (e.g., requesting UAV) and/or piloting WTRU (e.g., piloting UAV), respectively.

The target WTRU (e.g., target UAV) may be ready to receive the communication link/QoS monitoring report from the piloting WTRU (e.g., the piloting UAV). The communication link/QoS monitoring report may be received via a communication link, such as over the PC5 link. The target UAV may forward the received report to the aviation system.

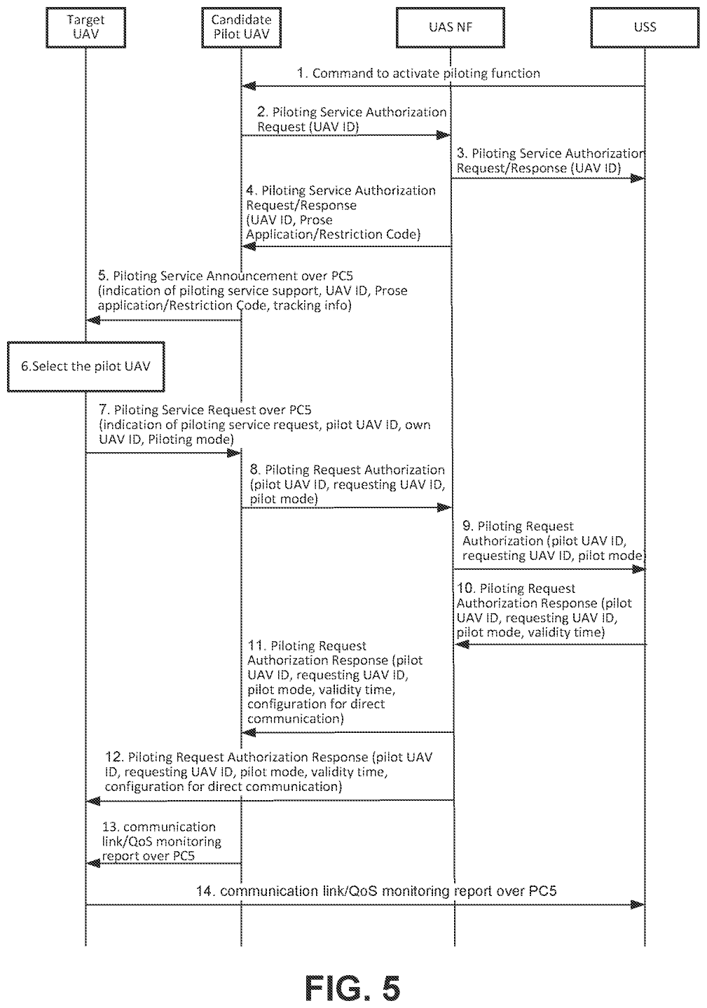

An example of the foregoing example of a discovery-based procedure, which may be referred to as a Model-A discovery-based procedure, is shown in FIG. 5. FIG. 5 illustrates an example of a procedure for cellular communication link monitoring assisted by a WRTU, which may be a pilot UAV.

As shown by example in FIG. 5, at 1, a candidate pilot WTRU (e.g., a candidate pilot UAV) may receive an application-layer command from the USS or UAV-C to activate the piloting service.

At 2, the candidate pilot WTRU (e.g., a candidate pilot UAV) may send the piloting service authorization request to the UAS NF (e.g., via AMF or SMF, which is not shown in FIG. 5). The candidate pilot WTRU (e.g., the candidate pilot UAV) may provide (e.g., in the piloting service authorization request) a WTRU ID, a UAV ID, and/or an indication that the request is for a piloting service).

At 3, the UAS NF may interact with the USS to verify that the WTRU (e.g., UAV) is allowed to provide a pilot service. The USS may provide other configuration information for the piloting service, such as the period of time that the WTRU (e.g., UAV) is allowed to perform a piloting service.

At 4, the UAS NF may inform the candidate pilot WTRU (e.g., candidate pilot UAV) about the service authorization result. The UAS NF may assign a ProSe application code or ProSe restriction code for the WTRU (e.g., UAV) to announce the code (e.g., over PC5) for discovery purposes. The UAS NF may forward the piloting service configuration to the candidate pilot WTRU (e.g., candidate pilot UAV).

At 5, the candidate pilot WTRU (e.g., candidate pilot UAV) may announce (e.g., over the PC5 channel) support for a piloting service. The announcement may include, for example, the ProSe application/restriction code, tracking information, a combination thereof, and/or the like.

At 6, the target WTRU (e.g., the target UAV), which is searching for a piloting WTRU (e.g., a piloting UAV), may monitor the candidate pilot WTRU's announcement (e.g., candidate pilot UAV's announcement). For example, the piloting WTRU may monitor the candidate pilot WTRU's announcement over the PC5 channel). The target WTRU (e.g., target UAV) may compare the candidate pilot WTRU's tracking information (e.g., candidate pilot UAV's tracking information) with the target WTRU's (e.g., target UAV's) planned flight route, for example, to determine whether the pilot WTRU's tracking information (e.g., pilot UAV's tracking information) is suitable for a piloting purpose. The target WTRU (e.g., target UAV) may select the candidate pilot WTRU (e.g., candidate pilot UAV) as a pilot WTRU (e.g., a pilot UAV), for example, if the candidate pilot WTRU (e.g., candidate pilot UAV) is flying (e.g., or has recently flown) within a distance of the area/altitude that the target WTRU (e.g., target UAV) may (e.g., is about to) enter. The target WTRU (e.g., target UAV) may receive a piloting announcement from multiple candidates. The target WTRU (e.g., target UAV) may select one or more WTRUs (e.g., one or more UAVs) as the pilot WTRU (e.g., pilot UAV).

At 7, the target WTRU (e.g., target UAV) may select the pilot WTRU (e.g., pilot UAV). The target WTRU (e.g., target UAV) may send a request over the PC5 channel to the pilot WTRU (e.g., pilot UAV) for piloting service. The target WTRU (e.g., target UAV) may provide the pilot WTRU ID (e.g., pilot UAV ID) and the target WTRUID (e.g., the target UAV ID) in the request, for example, to indicate to (e.g., any) other non-selected WTRUs and/or UAVs to ignore the request.

At 8, the pilot WTRU (e.g., pilot UAV) may receive the piloting service request. The pilot WTRU (e.g., pilot UAV) may initiate an authorization procedure, for example, to check whether the requesting WTRU (e.g., requesting UAV) is allowed to receive piloting information from (e.g., and/or generated by) the pilot WTRU (e.g., the pilot UAV).

At 9, the UAS NF may forward the request to the USS.

At 10, the USS may return the authorization result. The USS may provide other configuration information, such as a validity time, the frequency of monitoring report, a combination thereof, and/or the like.

At 11, the UAS NF may forward the authorization result to the pilot WTRU (e.g., the pilot UAV). The UAS NF may assign additional configuration, such as L2 identifiers, security parameters, etc., which may be used for (e.g., direct) communication over an interface, such as PC5.

At 12, the UAS NF may forward the authorization result and/or the configuration to the target WTRU (e.g., target UAV).

At 13, the piloting WTRU (e.g., piloting UAV) may (e.g., start to) send communication link and QoS monitoring information to the target WTRU (e.g., target UAV).

At 14, the target WTRU (e.g., target UAV) may forward the monitoring report to the USS, e.g., for flight route adjustment decisions.

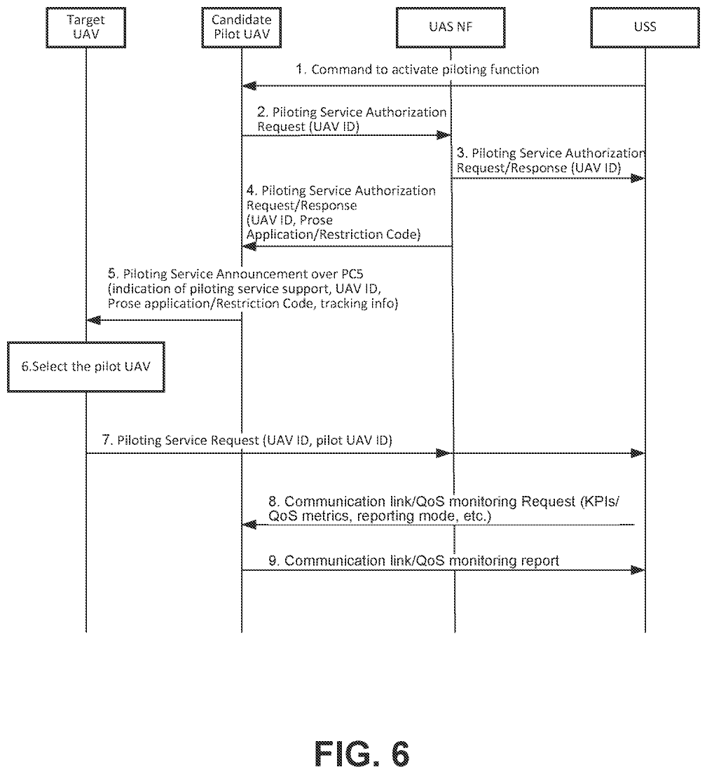

In some examples, the target WTRU (e.g., target UAV) may discover and select a pilot WTRU (e.g., pilot UAV). The discovery and selection may occur, for example, as described herein, such as at 1-6 in FIG. 5. The target WTRU (e.g., target UAV) may inform the aviation system of the selected pilot WTRU (e.g., UAV). The aviation system (e.g., USS) may request the pilot WTRU (e.g., pilot UAV) to report the communication link/QoS monitoring information to the aviation system, which may use the information to adjust the flight route, for example, instead of the target WTRU (e.g., target UAV) requesting and receiving the monitoring information from the pilot WTRU (e.g., pilot UAV) over an interface such as a PC5 link. The target UAV may select the pilot UAV based on broadcast information (e.g., broadcast remote ID information, tracking information, such as altitude, direction, etc.). The address of the USS serving the pilot WTRU (e.g., pilot UAV) may be resolved by the target WTRU (e.g., the target UAV) or UAS NF, for example, based on the pilot WTRU ID (e.g., the pilot UAV ID). An example of the foregoing example is shown in FIG. 6. In some examples (e.g., if UAVs are served by different USSs) the UAS NF may send a piloting request to the USS serving the target WTRU (e.g., target UAV), which may communicate with the USS serving the pilot WTRU (e.g., pilot UAV). The target WTRU's (e.g., target UAV's) USS may obtain QoS information from the pilot WTRU's (e.g., pilot UAV's) USS, which may obtain QoS information, for example, as described herein (e.g., in various examples).

FIG. 6 illustrates an example of a procedure for cellular communication link monitoring assisted by a WTRU, which may be a pilot UAV. At 1, the USS may send a message to a candidate pilot WTRU (e.g., candidate pilot UAV). The message may indicate command to activate a piloting function.

At 2, the candidate pilot WTRU (e.g., candidate pilot UAV) may send a message to the UAS NF that may indicate a request to authorize a piloting service (e.g., a piloting service authorization request).

At 3, the request may indicate a WTRU ID and/or a UAV ID. The UAS NF may send a message to the USS that may indicate a request to authorize a piloting service (e.g., a piloting service authorization request). The request may indicate a WTRU ID and/or a UAV ID.

At 4, the UAS NF may send a message to the candidate pilot WTRU (e.g., the candidate pilot UAV). The message may indicate a piloting service authorization response and/or response. For example, the message may indicate that the candidate pilot WTRU may be authorized to become a pilot WTRU (e.g., pilot UAV). As another example, the message may indicate that the candidate pilot WTRU (e.g., candidate pilot UC) may not be authorized to become a pilot WTRU (e.g., a pilot UAV). The message may indicate a WTRU ID, a UAV ID, an application (e.g., ProSe Application), a restriction code, a combination thereof, and/or the like.

At 5, the candidate pilot WTRU (e.g., the candidate pilot UAV) may send a message to the target WTRU (e.g., the target UAV). The message may indicate a piloting service announcement. The message may be sent over an interface, such as a PC5 interface. The message may indicate that the candidate pilot WTRU may capability of becoming a pilot WTRU (e.g., a pilot UAV). The message may indicate a capability of the candidate pilot WTRU. The message may indicate support for a piloting service, a WTRU ID, a UAV ID, a ProSe application/restriction code, tracking information, a combination thereof, and/or the like.

At 6, the target WTRU (e.g., the target UAV) may select a pilot WTRU (e.g., pilot UAV). For example, the target WTRU may determine that the candidate pilot WTRU may have the capability to be a pilot WTRU and may have been authorized to be the pilot WTRU.

At 7, the target WTRU (e.g., the target UAV) may send a message to the UAS NF and/or the USS. In an example, the UAS NF may receive the message and may send the message to the USS. In another example, the target WTRU may send the message to both the UAS NF and the USS. The message may indicate a piloting service request. The pallet servicing request may indicate that the target WTRU may have selected the candidate WTRU pilot as the pilot WTRU (e.g., pilot UAV). The message may indicate a WTRU ID, a UAV ID, a pilot UAV ID, an ID associated with the candidate pilot WTRU, a combination thereof, and/or the like.

At 8, the USS may send a message to the candidate pilot WTRU. For example, the USS may send a message indicating a communication link and/or QoS monitoring request to the candidate pilot WTRU (e.g., the pilot UAV). The message may indicate a KPI, a QoS metric, a reporting mode, a combination thereof, and/or the like.

At 9, the candidate pilot WTRU (e.g., the candidate pilot UAV) may send a message to the USS. For example, the candidate pilot WTRU (e.g., the candidate pilot UAV) may send a message that may indicate a communication link/QoS monitoring report to the USS.

QoS information may be based on predetermined/known flight paths. A procedure for flight path QoS prediction may be based on existing/identified flight paths and/or existing data. The procedure may be performed, for example, by a UAS NF.

A UAS NF may receive a request message for QoS monitoring from an USS. The request may indicate flight path reference information (e.g., a unique identifier assigned by the USS). The flight path reference information may identify a route (e.g., commonly) used by one or more WTRUs (e.g., one or more UAVs). The unique flight path reference may be shared among different USSs.

The UAS NF may send a request to an NF (e.g., network data analytics function (NWDAF), user data repository (UDR), unstructured data storage function (UDSF). The request may indicate flight path reference information. The request may be a request to receive and/or collect a QoS metric, a QoS report, a QoS parameter, a combination thereof, and/or the like. The UAS NF may receive QoS information associated with the flight path indicated in the request. The UAS NF may derive the communication link quality prediction for the flight path.

The UAS NF may send a response message to the USS. The request message may include the QoS information, and the prediction result associated with the flight path reference information.

In some examples, QoS information may not be returned by the NF. The UAS NF may initiate a procedure to obtain QoS information (e.g., as described herein). The QoS information may be obtained, for example, from one or more assisting or pilot WTRU (e.g., pilot UAVs). The UAS NF may request that the NF store the QoS information (e.g., along with the flight path reference information), for example, to be used to serve a subsequent request (e.g., as described herein).

WTRU-based QoS prediction and configuration (e.g., UAV-based QoS prediction and configuration) may be provided by a network (e.g., 3GPP network). An example procedure for a WTRU (e.g., UAV) to predict QoS degradation in real-time may be stand-alone (e.g., independent) and/or complementary to network based (e.g., UAS NF based) prediction.

For example, an USS may provide QoS metrics and thresholds to a UAS NF.

The WTRU (e.g., UAV) may receive one or more configurations from the UAS NF. External information received from the network may be applicable (e.g., and may be used) to configure a WTRU (UAV) for QoS monitoring.

The WTRU (e.g., UAV) may report QoS metrics information to the USS. The WTRU (e.g., UAV) may (e.g., additionally and/or alternatively) report (e.g., internally) to a UAS application or a local control entity within the WTRU (e.g., UAV).

The target WTRU (e.g., target UAV) may act as a reporting WTRU (e.g., reporting UAV) to itself. The target WTRU (e.g., target UAV) may collect QoS data. The target WTRU (e.g., target UAV) may process the collected data, for example, based on the history. The target WTRU (e.g., UAV) may perform machine learning (ML). The target WTUR (e.g., target UAV) may interpolate for (e.g., any) future changes or failure, for example, by comparing (pre) configured thresholds by the USS to the target WTRU (e.g., target UAV).

An application inside (e.g., a program executed by) the WTRU (e.g., UAV) may make use of the information. For example, an application may bring/return the WTRU (e.g., UAV) to a safe stop or interrupt safety critical services, e.g., based on (e.g., upon) detection of QoS degradation.

The WTRU (e.g., UAV) may react to the information and/or report the information and/or action(s) to the USS (e.g., via the UAS NF). The WTRU (e.g., UAV) may notify the UAS NF for QoS degradation, for example, so the WTRUs (e.g., UAVs) may timely be informed.

A system and/or apparatus (e.g., a WTRU) for monitoring a communication link and/or predicting a quality of a communication link may be provided. The WTRU may comprise a memory and/or a processor. The processor may be configured to perform a number of actions. A network area associated with a flight route being flown by a first WTRU (e.g., a first unmanned aerial vehicle (UAV) may be determined. A second WTRU (e.g., a second UAV) may be determined. The second WTRU may be associated with a network area. A first message may be second to the second WTRU. The first message may indicate an identity of the second WTRU and may indicate a request for the second WTRU to monitor a link within the network area. A second message may be received from the second WTRU. The second message may indicate the identity of the second UAV and may indicate a monitoring report from the second WTRU for the link. A third message may be sent to an aviation system. The second message my indicate a predicted communication link quality. The predicted communication link quality may be based on the monitoring report from the second UAV for the link.

A system and/or an apparatus for communication link and/or predicting a quality of a communication link (e.g., QoS monitoring) may be provided. First message may be sent to a first WTRU (e.g., a first unmanned aerial vehicle (UAV). The first message may indicate that the first WTRU may be authorized to provide a piloting service. A second message may be received from the second WTRU (e.g., second UAV). The second message may indicate an identity of the first WTRU and may indicate a request by second WTRU (e.g., second UAV) to use the piloting service provided by the first WTRU. A third message may be sent to the first WTRU. The third message may indicate an identity of the second WTRU. The third message may indicate that the first WTRU may be allowed to provide the piloting service to the second WTRU. The third message may indicate a communication configuration to be used to establish communication between the first WTRU and the second WTRU. A fourth message may be sent to the second WTRU. The fourth message may indicate that the first WTRU may be authorized to provide the piloting service. The fourth message may indicate the communication configuration.

A system and/or an apparatus for communication link and/or predicting a quality of a communication link (e.g., QoS monitoring) may be provided. A first WTRU (e.g., a first UAV). A first message may be received from a network. The first message may indicate that the first WTRU may be authorized to provide a piloting service. A second message may be sent to a second WTRU (e.g., a second UAV). The second message may indicate that the first WTRU (e.g., the first UAV) may be able to provide the authorized piloting service to the second WTRU. A third message may be received from the network. The third message may indicate an authorization for the first WTRU to monitor a link within a network area. The link and/or the network area may be associated with a flight route. The flight route may be a route flown by the second WTRU. A fourth message may be sent to the network. The fourth message may indicate a monitoring report for link.

A system and/or an apparatus for communication link and/or predicting a quality of a communication link (e.g., QoS monitoring) may be provided. A first message may be received from a second network node. The second network node may be associated with a second network. The first message may indicate an identity that may be associated with a first wireless transmit/receive unit (WTRU). The first WTRU may be a first UAV. The first message may indicate a flight route associated with the first WTRU. The first message may indicate a request for a prediction of a quality of a communication link associated with the flight route.

A second WTRU may be determined. The second WTRU may be a second UAV. A second WTRU may be determined that may be within a proximity to the flight route and that may be used to provide a quality of service (QOS) to assist in predicting the quality of the communication link. A second message may be sent to the second WTRU. The second message may indicate a request for the second WTRU to measure a QoS metric.

A third message may be received from the second WTRU. The third message may indicate the QoS metric. A report may be generated. The report may indicate the prediction of the quality of the communication link based on the QoS metric. A fourth message may be sent to the second network node. The fourth message may indicate the report.

In an example, the report may provide an estimation of reliability (e.g., overall reliability) of the communication link along the flight route. The report may provide one or more KPIs, such as average Packet Loss Rate, guaranteed bit rates, a combination thereof, and/or the like. The report may provide a general picture of the communication link quality along the route. For example, the report may indicate waypoints and/or areas that may have inferior communication quality.

In an example, the prediction of the quality of the communication link associated with the flight route may indicate an expected reliability of the communication link for a portion of the flight route.

In an example, determining that a second WTRU that may be within a proximity to the flight route and that may be used to provide a quality of service (QOS) to assist in predicting the quality of the communication link may comprise one or more actions. For example, a location associated with the second WTRU may be determined. It may be determined that the location may be within at least one of a distance or altitude of a portion of the flight route. It may be determined that the second WTRU is capable of performing a QoS measurement.

In an example, the location associated with the second WTRU may be one or more of a current location of the WTRU, a future location of the WTRU, a predicted location of the WTRU, a past location of the WTRU, and/or a real-time location of the WTRU.

In an example, the proximity to the flight route may be one or more of a distance from a point along the flight route, a distance range associated with a point along the flight route, an altitude associated with the flight route, an altitude range associated with the flight route, or an area associated with the flight route.

In an example, the QoS metric may be one or more of a bandwidth, a delay, a data loss, a packet loss, a jitter, or a signal strength.

In an example, the QoS metric may be a first QoS metric and the QoS metric may be a first Qos metric, and the proximity to the flight route may be a first proximity. A third WTRU may be determined that may be within a second proximity to the flight route and that may be used to measure the QoS. A fifth message may be sent to the third WTRU. The fifth message may indicate a request for the third WTRU to measure a second QoS metric.

In an example, sixth message may be received from the third WTRU. The sixth message indicates the second QoS metric.

In an example, the report may be generated by determining the prediction of the quality of the communication link using the first QoS metric and the second QoS metric.

In an example, the second network node may be associated with an aviation system.

A system and/or an apparatus for communication link and/or predicting a quality of a communication link (e.g., QoS monitoring) may be provided. A first message may be received from a second network node. The second network node may be associated with an aviation system. The first message may indicate an identity of a first wireless transmit/receive unit (WTRU). The first WTRU may be a first UAV. The first message may indicate a flight route associated with the first WTRU. The first message may indicate a request for a prediction of a quality of a communication link associated with the flight route

A second message may be sent to a second WTRU. The second WTRU may be a second UAV. The second WTRU may be within a first proximity of the flight route. The second message may indicate a request for the second WTRU to measure a first quality of service (Qos) metric.

A third message to a third WTRU. The third WTRU may be a third UAV. The third WTRU may be within a second proximity of the flight route. The third message may indicate a request for the third WTRU to measure a second QoS metric.

A fourth message may be received from the second WTRU. The fourth message may indicate the first QoS metric.

A fifth message may be received from the third WTRU. The fifth message may indicate the second QoS metric.

A report may be generated. The report may indicate that the prediction of the quality of the communication link associated with the flight route. The report may be generated using the first QoS metric and/or the second QoS metric. The prediction of the quality may be determined using the first QoS metric and/or the second QoS metric.

A six message may be sent to the second network node. The six message may indicate the report.

In an example, the prediction of the quality of the communication link associated with the flight route may indicate an expected reliability of the communication link for a portion of the flight route.

In an example, it may be determined that the second WTRU may be within a first proximity to the flight route and that the second WTRU may be used to provide the QoS to assist in predicting the quality of the communication link. A location associated with the second WTRU may be determined. It may be determined that the location may be within at least one of a distance and/or altitude of a portion of the flight route. It may be determined that the second WTRU may be capable of performing a QoS measurement.

In an example, the location associated with the second WTRU may be one or more of a current location of the WTRU, a future location of the WTRU, a predicted location of the WTRU, a past location of the WTRU, and/or a real-time location of the WTRU.

In an example, the first proximity to the flight route may be one or more of a distance from a point along the flight route, a distance range associated with a point along the flight route, an altitude associated with the flight route, an altitude range associated with the flight route, and/or an area associated with the flight route.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A first network node, the first network node comprising:
a processor, wherein the processor is configured to:
receive a first message from a second network node, wherein the second network node is associated with a second network, and wherein the first message indicates an identity associated with a first wireless transmit/receive unit (WTRU), indicates a flight route associated with the first WTRU, and indicates a request for a prediction of a quality of a communication link associated with the flight route;
determine a second WTRU that is within a proximity to a portion of the flight route and that can be used to measure a quality of service (QOS) metric;
send a second message to the second WTRU if the second WTRU is within the proximity to the portion of the flight route, wherein the second message indicates a request for the second WTRU to measure the QoS metric;
receive a third message from the second WTRU, wherein the third message indicates the QoS metric;
determine the prediction of the quality of the communication link using the QoS metric; and
send a fourth message to the second network node, wherein the fourth message indicates the prediction of the quality of the communication link.

22. The first network node of claim 21, wherein prediction of the quality of the communication link associated with the flight route indicates an expected reliability of the communication link for the portion of the flight route.

23. The first network node of claim 21, wherein the processor being configured to determine a second WTRU that is within the proximity to the portion of the flight route and that can be used to measure the QoS metric comprises the processor being configured to:
determine a location associated with the second WTRU;
determine that the location is within at least one of a distance or altitude of the portion of the flight route; and
determine that the second WTRU is capable of performing a QoS measurement.

24. The first network node of claim 23, wherein the location associated with the second WTRU is at least one of a current location of the WTRU, a future location of the WTRU, a predicted location of the WTRU, a past location of the WTRU, or a real-time location of the WTRU.

25. The first network node of claim 21, wherein the proximity to the portion of the flight route is at least one of a distance from a point along the flight route, a distance range associated with a point along the flight route, an altitude associated with the flight route, an altitude range associated with the flight route, or an area associated with the flight route.

26. The first network node of claim 21, wherein the QoS metric is at least one of a bandwidth, a delay, a data loss, a packet loss, a jitter, or a signal strength.

27. The first network node of claim 1, wherein the QoS metric is a first QoS metric, wherein the portion of the flight route is a first portion, wherein the proximity to the first portion of the flight route is a first proximity, and wherein the processor is further configured to:
determine a third WTRU that is within a second proximity to a second portion of the flight route; and
send a fifth message to the third WTRU, wherein the fifth message indicates a request for the third WTRU to measure a second QoS metric.

28. The first network node of claim 27, wherein the processor is further configured to receive a sixth message from the third WTRU, wherein the sixth message indicates the second QoS metric.

29. The first network node of claim 27, wherein the processor being configured to determine the prediction of the quality of the communication link by using the first QoS metric further comprises the processor being configured to determine the prediction of the quality of the communication link by using the first QoS metric and the second QoS metric.

30. The first network node of claim 21, wherein the second network node is associated with an aviation system.

31. A method performed by a first network node associated with a first network, the method comprising:
receiving a first message from a second network node, wherein the second network node is associated with a second network, and wherein the first message indicates an identity associated with a first wireless transmit/receive unit (WTRU), indicates a flight route associated with the first WTRU, and indicates a request for a prediction of a quality of a communication link associated with the flight route;
determining a second WTRU that is within a proximity to a portion of the flight route and that can be used to provide a quality of service (QOS);
sending a second message to the second WTRU if the second WTRU is within the proximity to the portion of the flight route, wherein the second message indicates a request for the second WTRU to measure a QoS metric;
receiving a third message from the second WTRU, wherein the third message indicates the QoS metric;
determining the prediction of the quality of the communication link using the QoS metric; and
sending a fourth message to the second network node, wherein the fourth message indicates the prediction of the quality of the communication link.

32. The method of claim 31, wherein prediction of the quality of the communication link associated with the flight route indicates an expected reliability of the communication link for a portion of the flight route.

33. The method of claim 31, wherein determining a second WTRU that is within the proximity to the flight route and that can be used to provide the QoS:
determining a location associated with the second WTRU;
determining that the location is within at least one of a distance or altitude of a portion of the flight route; and
determining that the second WTRU is capable of performing a QoS measurement.

34. The method of claim 33, wherein the location associated with the second WTRU is at least one of a current location of the WTRU, a future location of the WTRU, a predicted location of the WTRU, a past location of the WTRU, or a real-time location of the WTRU.

35. The method of claim 31, wherein proximity to the flight route is at least one of a distance from a point along the flight route, a distance range associated with a point along the flight route, an altitude associated with the flight route, an altitude range associated with the flight route, or an area associated with the flight route.

36. A first network node, the first network node comprising:
a processor, the processor configured to:
receive a first message from a second network node, wherein the second network node is associated with an aviation system, and wherein the first message indicates an identity of a first wireless transmit/receive unit (WTRU), indicates a flight route associated with the first WTRU, and indicates a request for a prediction of a quality of a communication link associated with the flight route;
send a second message to a second WTRU, wherein the second WTRU is within a first proximity of a first portion of the flight route, and wherein the second message indicates a request for the second WTRU to measure a first quality of service (QOS) metric;
send a third message to a third WTRU, wherein the third WTRU is within a second proximity of a second portion of the flight route, and wherein the third message indicates a request for the third WTRU to measure a second QoS metric;
receive a fourth message from the second WTRU, wherein the fourth message indicates the first QoS metric;
receive a fifth message from the third WTRU, wherein the fifth message indicates the second QoS metric;
generate a report that indicates the prediction of the quality of the communication link associated with the flight route using the first QoS metric and the second QoS metric; and
send a six message to the second network node, wherein the six message indicates the report.

37. The first network node of claim 36, wherein the prediction of the quality of the communication link associated with the flight route indicates an expected reliability of the communication link.

38. The first network node of claim 36, wherein the processor being configured to determine that the second WTRU is within the first proximity to the flight route comprises the processor being configured to:
determine a location associated with the second WTRU;
determine that the location is within at least one of a distance or altitude of a portion of the flight route; and
determine that the second WTRU is capable of performing a QoS measurement.

39. The first network node of claim 38, wherein the location associated with the second WTRU is at least one of a current location of the WTRU, a future location of the WTRU, a predicted location of the WTRU, a past location of the WTRU, or a real-time location of the WTRU.

40. The first network node of claim 36, wherein the first proximity to the first portion of the flight route is at least one of a distance from a point along the flight route, a distance range associated with a point along the flight route, an altitude associated with the flight route, an altitude range associated with the flight route, or an area associated with the flight route.
